(19) United States
(12) Patent Application Publication
(10) Pub. No.: US 2012/0265556 A1
(43) Pub. Date: Oct. 18, 2012

(54) METHOD AND DEVICE FOR REMOTE CONTROLLED APPLICATION OF MEDICAL MONITORING AND ATTENTION

(76) Inventor: Shamir Lebovitz, Tel-Aviv (IL)

(21) Appl. No.: 13/508,824

(22) PCT Filed: Nov. 16, 2010
(86) PCT No.: PCT/IL10/00950

§ 371 Date: Jun. 28, 2012

Related U.S. Application Data
(60) Provisional application No. 61/261,764, filed on Nov. 17, 2009.

(51) Int. Cl. G06Q 50/22

(52) U.S. Cl. 705/2

(57) ABSTRACT

The present invention discloses a device useful for monitoring of patient condition and remote treatment administration, comprising: a. at least one portable monitoring means adapted to (i) acquire predetermined parameters from a patient for analysis; and. (ii) store said data in communicable database; b. at least one portable treatment administration means for remote administration of medical treatment; at least one computerized software program either wire or wirelessly connected with said mobile apparatus, adapted to (i) analyze said predetermined parameters acquired by said monitoring means; and, (ii) allow said remote treatment administration by said treatment administration means.

### FIELD OF THE INVENTION

The present invention generally pertains to an improved device and method for the application of remote medical monitoring and attention to any patient in need or any patient at high risk.

### BACKGROUND OF THE INVENTION

Conventional provision of medical attention at hospitals is giving way to outpatient service at clinics, at home and on the go. Mobile devices that can be comfortably carried and enable patients suffering from a wide array of diseases from diabetes to heart disorder to monitor their condition, as well as apply measures to counter a detected abnormality in the function of their organs.

U.S. Pat. No. 4,928,690 discloses a patient worn vest with integrated sensors that monitor and register cardiac function. An onboard computer compares the stored data with the incoming data assessing the need to induce defibrillation, which is applied through integrated electrodes. Additionally a telephone linkup is provided to allow remotely located medical personnel to occasionally review the recorded log as well as a verbally communicate with the patient.

Although the current art provides remote review of recorded data as well as online communication with the patient, it relies on either the onboard computer or on the patient to initiate the administration of treatment. If the patient is verbally debilitated or incapable for some reason to provide treatment to himself , he might be left without treatment.

Alternatively, if the onboard software is unable to reach a conclusion, the patient is left without treatment.

Accordingly, a method and device for both remotely assessing patient's condition, including their state of consciousness, as well as remotely initiating the treatment would be beneficial.

### SUMMARY OF THE INVENTION

It the object of the present invention to present a device useful for monitoring of medical conditions as well as the remote administration of treatment comprising at least one mobile monitoring means capable of acquiring data or samples for analysis; at least one portable two way data communications apparatus; at least one mobile apparatus for remote administration of medical treatment; at least one mobile computerized system interconnected with said mobile analysis means, said two way communications means, and said treatment administration means; at least one software program incorporated in said mobile computerized system offering control over said monitoring means and said treatment administration means, as well as relaying data and remote commands utilizing said interconnected two way communication apparatus; and at least one remote interface enabling the remote control of said mobile computerized system, incorporating at least one two way communications means.

It is in the scope of the present invention wherein said remote monitoring and treatment application device incorporates a defibrillator.

It is further within the scope of the present invention wherein said monitoring and treatment device is capable of ascertaining the consciousness of the patient.

It is further within the scope of the present invention wherein said monitoring and treatment device incorporates audible or visual warnings as to its operation.

It is further within the scope of the present invention wherein said monitoring and treatment device incorporates an intravenous drug dispenser.

It is in the scope of the present invention wherein said remote monitoring and treatment application device is shaped in a wearable form.

It is further in the scope of the present invention wherein said remote monitoring and treatment application device is attachable and detachable for the patient.

It is further in the scope of the present invention wherein said remote monitoring and treatment and treatment application device is implanted in the patient.

It is further in the scope of the present invention wherein said remote monitoring and treatment and treatment application device is constructed in accordance with nanotechnology, contained within a capsule, and ingested by the patient.

It is further in the scope of the present invention wherein said remote monitoring and treatment and treatment application device is constructed in accordance with nanotechnology, and is injected into the patient's bloodstream.

It is also within the scope of the present invention wherein the monitoring element of said remote monitoring and treatment and treatment application device is an electrode.

It is also within the scope of the present invention wherein the monitoring element of said remote monitoring and treatment and treatment application device is at least one electrode.

It is also within the scope of the present invention wherein the monitoring element of said remote monitoring and treatment and treatment application device is at least one electro chemical probe.

It is also within the scope of the present invention wherein the monitoring element of said remote monitoring and treatment and treatment application device is at least one conventional electro chemical blood sugar monitor.

It is also within the scope of the present invention wherein the communication element of said remote monitoring and treatment and treatment application device with a distanced expert system is a landline.

It is also within the scope of the present invention wherein the communication element of said remote monitoring and treatment and treatment application device with a distanced expert system is radio frequency based.

It is also within the scope of the present invention wherein the communication element of said remote monitoring and treatment and treatment application device with a distanced expert system is assisted by satellite communication.

It is also within the scope of the present invention wherein the communication element of said remote monitoring and treatment and treatment application device with a distanced expert system is assisted by a web server.

It is one object of the present invention to provide a device useful for monitoring of patient condition and remote treatment administration, comprising:
a. at least one portable monitoring means adapted to (i) acquire predetermined parameters from a patient for analysis; and. (ii) store said data in communicable database;
b. at least one portable treatment administration means for remote administration of medical treatment;
c. at least one computerized software program either wire or wirelessly connected with said mobile apparatus, adapted to (i) analyze said predetermined parameters acquired by said monitoring means; and, (ii) allow said remote treatment administration by said treatment administration means.

It is another object of the present invention to provide the device as defined above, wherein said computerized software program either wire or wirelessly transmit at least one selected from a group consisting of (i) said analysis of said predetermined parameters; (ii) said predetermined parameters, or any combination thereof to an expert system adapted to perform an independence analysis of said predetermined parameters.

It is another object of the present invention to provide the device as defined above, wherein said expert system further adapted to allow said remote treatment administration by said treatment administration means.

It is another object of the present invention to provide the device as defined above, wherein either one of said expert system or said computerized software program provides diagnosis of said patient based upon said parameters.

It is another object of the present invention to provide the device as defined above, additionally comprising at least one portable two way data communications apparatus.

It is another object of the present invention to provide the device as defined above, at least one remote interface enabling the remote control of said mobile computerized system, incorporating at least one two way communications means.

It is another object of the present invention to provide the device as defined above, additionally comprising a feedback mechanism, adapted to change said treatment according to predetermined medical needs; said feedback mechanism comprising:
a. sensing means; adapted to sense predetermined parameters selected from a group consisting of blood pressure, heart rate, heart pulses, cardiac standstill, Ventricular tachycardia or V-tach or VT, Atrial fibrillation (AF or A-fib) or any combination thereof;
b. processing means, adopted to score said predetermined parameters according to a predetermined scale of treatment success; and,
c. regulating means, adapted to allow said treatment if said score is higher than a predetermined value and to stop said treatment if said score is lower than a predetermined value.

It is another object of the present invention to provide the device as defined above, wherein the device is wearable.

It is another object of the present invention to provide the device as defined above, wherein the device is attachable and detachable from the patient.

It is another object of the present invention to provide the device as defined above, wherein the device is implanted under the patient's skin.

It is another object of the present invention to provide the device as defined above, wherein the device is constructed in accordance with nanotechnology and is contained within a capsule and ingested by the patient.

It is another object of the present invention to provide the device as defined above, wherein the device is constructed in accordance with nanotechnology and is injected into the patient's bloodstream.

It is another object of the present invention to provide the device as defined above, wherein the monitoring means are at least one electrode.

It is another object of the present invention to provide the device as defined above, wherein the monitoring means are at least one electro chemical probe.

It is another object of the present invention to provide the device as defined above, wherein the monitoring means is a conventional electro chemical blood sugar monitor.

It is another object of the present invention to provide the device as defined above, wherein the two way communication is landline based.

It is another object of the present invention to provide the device as defined above, wherein the two way communication is radio frequency based.

It is another object of the present invention to provide the device as defined above, wherein the two way communication is assisted by satellite communication.

It is another object of the present invention to provide the device as defined above, wherein the two way communication is assisted by a web server.

It is another object of the present invention to provide the device as defined above, wherein said apparatus for administration of medical treatment is a defibrillator.

It is another object of the present invention to provide the device as defined above, wherein a warning is sounded prior to remote activation of said defibrillator.

It is another object of the present invention to provide the device as defined above, wherein said warning is audile.

It is another object of the present invention to provide the device as defined above, wherein said warning is visual.

It is another object of the present invention to provide the device as defined above, wherein said portable treatment administration means comprises an intravenous drug dispenser.

It is another object of the present invention to provide the device as defined above, wherein said portable monitoring means is capable of ascertaining the consciousness of the patient.

It is another object of the present invention to provide the device as defined above, wherein said two way communication means incorporates a two way voice communication capability.

It is another object of the present invention to provide the device as defined above, wherein said computerized software program includes an artificial intelligence based expert system.

It is another object of the present invention to provide the device as defined above, wherein said two way data communication means provides access to a remote artificial intelligence based expert system.

It is another object of the present invention to provide the device as defined above, wherein said computerized software program in integrated within a mobile phone.

It is another object of the present invention to provide the device as defined above, wherein said mobile phone incorporated a memory that records a history of monitored data.

It is another object of the present invention to provide the device as defined above, additionally comprising GPS device.

It is another object of the present invention to provide a method of distance monitoring patients and provisioning medical treatment, said method comprising:
a. obtaining a mobile monitoring and medical treatment administration device, comprising
   i. at least one portable monitoring means adapted to (i) acquire predetermined parameters from a patient for analysis; and. (ii) store said data in communicable database;
   ii. at least one portable treatment administration means for remote administration of medical treatment; and,
   iii. at least one computerized software program either wire or wirelessly connected with said mobile apparatus, adapted to (i) analyze said predetermined parameters acquired by said monitoring means; and, (ii) allow said remote treatment administration by said treatment administration means;
b. interconnecting said portable monitoring means and said portable treatment administration means to said patient;
c. monitoring said patient's condition by means of said portable monitoring means;
d. either wire or wirelessly analyzing said predetermined parameters; and,
e. based on said predetermined parameters treating said patient.

It is another object of the present invention to provide the method as defined above, wherein said step (d) of analyzing provide diagnosis of said patient.

It is another object of the present invention to provide the method as defined above, additionally comprising steps of:
a. relaying said data to either to a remote or local, computerized or human expert;
b. receiving direction from said expert system;
c. alerting patient and their proximity of the decision to administer treatment;
d. prompting the patient and their proximity to raise objection to remote treatment;
e. activating said remote dispenser of medical treatment;
f. monitoring the effect of said remote treatment;
g. alerting first aid staff of the gravity of patient's situation;
h. dispatching a first aid staff to the patient's location.

It is another object of the present invention to provide the method as defined above, additionally comprising step of either wire or wirelessly transmitting at least one selected from a group consisting of (i) said analysis of said predetermined parameters; (ii) said predetermined parameters, or any combination thereof to an expert system adapted to perform an independence analysis of said predetermined parameters.

It is another object of the present invention to provide the method as defined above, additionally comprising step of allowing said remote treatment administration by said treatment administration means by mean of said expert system.

It is another object of the present invention to provide the method as defined above, additionally comprising step of diagnosing said patient based upon said parameters by either one of said expert system or said computerized software program.

It is another object of the present invention to provide the method as defined above, additionally comprising step of feedbackly changing said treatment according to predetermined medical needs.

It is another object of the present invention to provide the method as defined above, additionally comprising step of providing said device with a feedback mechanism; said feedback mechanism comprising:
a. sensing means; adapted to sense predetermined parameters selected from a group consisting of blood pressure, heart rate, heart pulses, cardiac standstill, Ventricular tachycardia or V-tach or VT, Atrial fibrillation (AF or A-fib) or any combination thereof;
b. processing means, adopted to score said predetermined parameters according to a predetermined scale of treatment success; and,
c. regulating means, adapted to allow said treatment if said score is higher than a predetermined value and to stop said treatment if said score is lower than a predetermined value.

It is another object of the present invention to provide the method as defined above, additionally comprising steps of
a. sensing predetermined parameters selected from a group consisting of blood pressure, heart rate, heart pulses, cardiac standstill, Ventricular tachycardia or V-tach or VT, Atrial fibrillation (AF or A-fib) or any combination thereof;
b. scoring said predetermined parameters according to a predetermined scale of treatment success; and,
c. allowing said treatment if said score is higher than a predetermined value or stopping said treatment if said score is lower than a predetermined value

It is another object of the present invention to provide the method, as defined above, additionally comprising step of implanting said device under the patient's skin.

It is another object of the present invention to provide the method as defined above, additionally comprising step of constructing said device in accordance with nanotechnology and containing the same within a capsule and ingested by the patient.

It is another object of the present invention to provide the method as defined above, additionally comprising step of constructing said device in accordance with nanotechnology and injecting the same into the patient's bloodstream.

It is another object of the present invention to provide the method as defined above, additionally comprising step of selecting said monitoring means from at least one electrode, at least one electro chemical probe, a conventional electro chemical blood sugar monitor or any combination thereof.

It is another object of the present invention to provide the method as defined above, additionally comprising step of either communicating said parameters via landline based, radio frequency, via satellite communication, via web server or any combination thereof.

It is another object of the present invention to provide the method as defined above, additionally comprising step of selecting said portable treatment administration means from defibrillator.

It is another object of the present invention to provide the method as defined above, additionally comprising step of transmitting a warning prior to remote activation of said defibrillator.

It is another object of the present invention to provide the method as defined above, additionally wherein said warning signal is audile, visual or any combination thereof.

It is another object of the present invention to provide the method as defined above, additionally comprising step of selecting said portable treatment administration means from intravenous drug dispenser.

It is another object of the present invention to provide the method as defined above, additionally comprising step ascertaining the consciousness of the patient.

It is another object of the present invention to provide the method as defined above, additionally comprising step of providing said computerized software program with an artificial intelligence based expert system.

It is another object of the present invention to provide the method as defined above, additionally comprising step of providing said computerized software program said integrated within a mobile phone.

It is still an object of the present invention to provide the method as defined above, additionally comprising step of providing said mobile phone incorporated a memory that records a history of monitored data.

It is lastly an object of the present invention to provide the method as defined above, additionally comprising step of providing said device with GPS device.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 is not to scale illustration of the elements of a portable embodiment of a remote monitoring and treatment administration system, incorporating a computerized processing unit interconnected with a monitoring element, a communication element, and treatment dispenser element and,

FIG. 2 is a schematic representation of the method of operation of a remote monitoring and treatment system incorporating a distanced expert system that receives data from the mobile unit attached to the patient, ascertains the proper course of treatment and instructs the mobile unit accordingly.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an improved device and method for remote monitoring and administration of medical attention.

The device and method of the present invention are useful for monitoring of patient condition and remote administration of treatment. It can be used for a plurality of ailments ranging from heart disease to diabetics. The portable device incorporates:
(a) a monitoring element for the disease in question;
(b) a treatment dispenser element;
(c) a local computerized data processing and storage element; and,
(d) a communication element.

The monitoring element enables distanced medical personnel to keep track of the patient, as well as ascertain their consciousness.

The communication element enables the system to wirelessly/remotely contact to a distanced expert system, either human or computerized, in order to assist the local computerized data processing element in ascertaining the proper course of action in terms of treatment.

Additionally the system is capable of issuing warnings signal (either vocally or used the aid of lights) to the patient and their surroundings if the system detects an abnormality in one of the sensed parameters.

Additionally the system is capable of issuing warnings signal (either vocally or used the aid of lights) to the patient and their surroundings as to the action about to be taken.

Additionally the system is capable of issuing warnings signal (either vocally or used the aid of lights) to the patient and their surroundings as to the location of the patient in need (e.g. by using GPS)

Finally, the system is capable of calling first aid personnel to the assistance of the patient.

The term ‘web server’ refers hereinafter to any communication that is relayed by means of internet data transfer.

The term ‘defibrillator’ refers hereafter to any means of inducing electrical shock to the patient in order to reactivate their cardiovascular system.

The term ‘electro chemical probe’ refers hereafter to any means of testing the chemical levels with the patient's bloodstream.

The term ‘nanotechnology’ refers hereafter to a body of knowledge that miniaturizes mechanical and other technological elements to the degree that they may travel in the human bloodstream and be instructed to conduct repair work therein.

The term ‘expert system’ refers hereafter to any means of knowledge or expertise, either human or based on a database assisted by computerized artificial intelligence.

The term ‘GPS’ refers hereafter to a global position system that is capable of indicating a physical location anywhere on the globe.

In a preferred embodiment of the present invention the mobile patient monitoring remote administration of treatment device incorporates a defibrillator.

In yet another preferred embodiment of the present invention the mobile patient monitoring remote administration of treatment device incorporates a drug dispensing means.

In yet another preferred embodiment of the present invention the mobile patient monitoring remote administration of treatment device is implanted in the patient.

In yet another preferred embodiment of the present invention the mobile patient monitoring remote administration of treatment device is constructed from nanotechnology and either ingested or injected into the patient.

In yet another preferred embodiment of the present invention the mobile patient monitoring remote administration of treatment device incorporates a communication element for data transfer with a distanced expert system.

In yet another preferred embodiment of the present invention the mobile patient monitoring remote administration of treatment device incorporates a communication element that utilizes a landline, radio frequency, satellite, web server or any combination thereof.

In yet another preferred embodiment of the present invention, the mobile patient monitoring remote administration of treatment device incorporates a GPS transmitter for relaying the patient's physical location to first aid personnel.

The device and method of the present invention has many technology advantages, among them:
Enhanced monitoring and treating chronic ailments.
Compact dimensions.
Ease of use.

Additional features and advantages of the invention will become apparent from the following drawings and description.

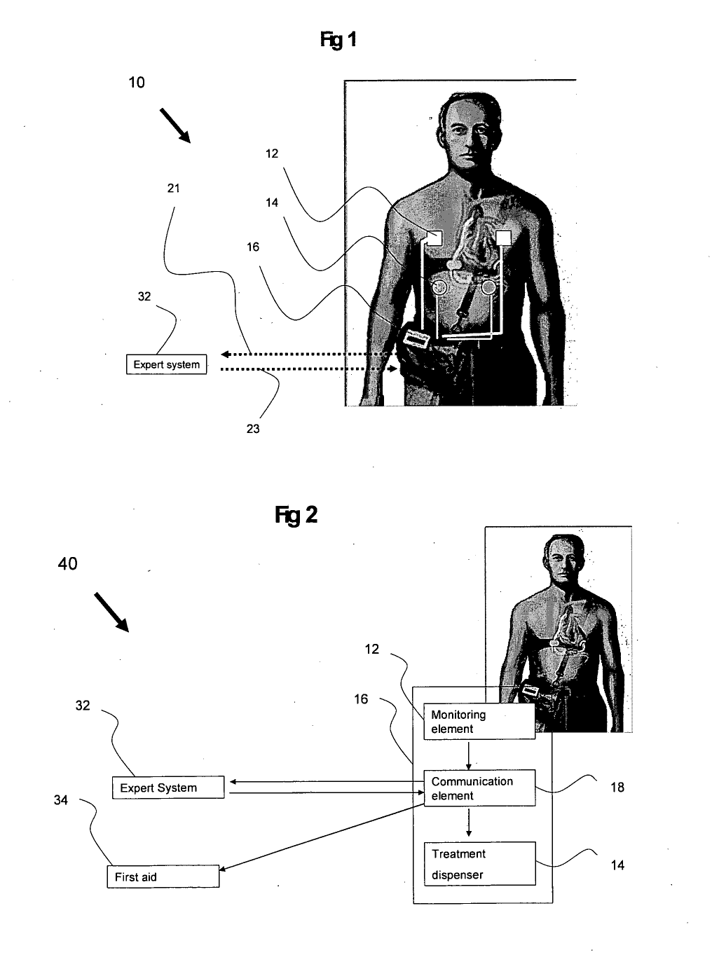

FIG. 1 is a not to scale illustration of a preferred embodiment of the present invention 10. In which monitoring element 12 acquires data on the patients condition and stores it by means of computerized apparatus 16 and transmits it 21 by mean of a communication element (not shown) to an expert system 32.

Expert system 32 (either machine of human) advises on the appropriate medical course of action; communicates it 23 to the computerized apparatus 16 by a communication means (not shown).

Consequently computerized apparatus 16 instructs treatment dispenser 14 to dispense treatment.

Alternatively, computerized apparatus 16 instructs the treatment means to treat the patient (e.g., dispense a medicament, apply electrical treatment, apply electro chemical treatment or any combination thereof)

FIG. 2 is a schematic representation of a preferred method 40 of operation of the present invention.

The method comprises steps selected inter alia from monitoring preselected parameters by the monitor element 12; communicating the patient's readings to a mobile computerized processing unit 16; relaying the processed readings via communication element 18 to expert system 32; analyzing and ascertaining the appropriate measurements to be taken and relays them via communication element 18 to computerized processing unit 16.

Thereafter, the computerized processing element 16 or the expert system 32 instructs the treatment dispenser 14 to induce treatment to the patient.

Alternatively or additionally the computerized processing element 16 communicates via communication element 18 a call for attendance of first personnel 34.

It is one object of the present invention to provide a device useful for monitoring of patient condition and remote treatment administration, comprising:
d. at least one portable monitoring means adapted to (i) acquire predetermined parameters from a patient for analysis; and. (ii) store said data in communicable database;
e. at least one portable treatment administration means for remote administration of medical treatment;
f. at least one computerized software program either wire or wirelessly connected with said mobile apparatus, adapted to (i) analyze said predetermined parameters acquired by said monitoring means; and, (ii) allow said remote treatment administration by said treatment administration means.

It is another object of the present invention to provide the device as defined above, wherein said computerized software program either wire or wirelessly transmit at least one selected from a group consisting of (i) said analysis of said predetermined parameters; (ii) said predetermined parameters, or any combination thereof to an expert system adapted to perform an independence analysis of said predetermined parameters.

It is another object of the present invention to provide the device as defined above, wherein said expert system further adapted to allow said remote treatment administration by said treatment administration means.

It is another object of the present invention to provide the device as defined above, wherein either one of said expert system or said computerized software program provides diagnosis of said patient based upon said parameters.

It is another object of the present invention to provide the device as defined above, additionally comprising at least one portable two way data communications apparatus.

It is another object of the present invention to provide the device as defined above, at least one remote interface enabling the remote control of said mobile computerized system, incorporating at least one two way communications means.

It is another object of the present invention to provide the device as defined above, additionally comprising a feedback mechanism, adapted to change said treatment according to predetermined medical needs; said feedback mechanism comprising:
d. sensing means; adapted to sense predetermined parameters selected from a group consisting of blood pressure, heart rate, heart pulses, cardiac standstill, Ventricular tachycardia or V-tach or VT, Atrial fibrillation (AF or A-fib) or any combination thereof;
e. processing means, adopted to score said predetermined parameters according to a predetermined scale of treatment success; and,
f. regulating means, adapted to allow said treatment if said score is higher than a predetermined value and to stop said treatment if said score is lower than a predetermined value.

It is another object of the present invention to provide the device as defined above, wherein the device is wearable.

It is another object of the present invention to provide .the device as defined above, wherein the device is attachable and detachable from the patient.

It is another object of the present invention to provide the device as defined above, wherein the device is implanted under the patient's skin.

It is another object of the present invention to provide the device as defined above, wherein the device is constructed in accordance with nanotechnology and is contained within a capsule and ingested by the patient.

It is another object of the present invention to provide the device as defined above, wherein the device is constructed in accordance with nanotechnology and is injected into the patient's bloodstream.

It is another object of the present invention to provide the device as defined above, wherein the monitoring means are at least one electrode.

It is another object of the present invention to provide the device as defined above, wherein the monitoring means are at least one electro chemical probe.

It is another object of the present invention to provide the device as defined above, wherein the monitoring means is a conventional electro chemical blood sugar monitor.

It is another object of the present invention to provide the device as defined above, wherein the two way communication is landline based.

It is another object of the present invention to provide the device as defined above, wherein the two way communication is radio frequency based.

It is another object of the present invention to provide the device as defined above, wherein the two way communication is assisted by satellite communication.

It is another object of the present invention to provide the device as defined above, wherein the two way communication is assisted by a web server.

It is another object of the present invention to provide the device as defined above, wherein said apparatus for administration of medical treatment is a defibrillator.

It is another object of the present invention to provide the device as defined above, wherein a warning is sounded prior to remote activation of said defibrillator.

It is another object of the present invention to provide the device as defined above, wherein said warning is audile.

It is another object of the present invention to provide the device as defined above, wherein said warning is visual.

It is another object of the present invention to provide the device as defined above, wherein said portable treatment administration means comprises an intravenous drug dispenser.

It is another object of the present invention to provide the device as defined above, wherein said portable monitoring means is capable of ascertaining the consciousness of the patient.

It is another object of the present invention to provide the device as defined above, wherein said two way communication means incorporates a two way voice communication capability.

It is another object of the present invention to provide the device as defined above, wherein said computerized software program includes an artificial intelligence based expert system.

It is another object of the present invention to provide the device as defined above, wherein said two way data communication means provides access to a remote artificial intelligence based expert system.

It is another object of the present invention to provide the device as defined above, wherein said computerized software program in integrated within a mobile phone.

It is another object of the present invention to provide the device as defined above, wherein said mobile phone incorporated a memory that records a history of monitored data.

It is another object of the present invention to provide the device as defined above, additionally, comprising GPS device.

It is another object of the present invention to provide a method of distance monitoring patients and provisioning medical treatment, said method comprising:
b. obtaining a mobile monitoring and medical treatment administration device, comprising
   iv. at least one portable monitoring means adapted to (i) acquire predetermined parameters from a patient for analysis; and. (ii) store said data in communicable database;
   v. at least one portable treatment administration means for remote administration of medical treatment; and,
   vi. at least one computerized software program either wire or wirelessly connected with said mobile apparatus, adapted to (i) analyze said predetermined parameters acquired by said monitoring means; and, (ii) allow said remote treatment administration by said treatment administration means;
f. interconnecting said portable monitoring means and said portable treatment administration means to said patient;
g. monitoring said patient's condition by means of said portable monitoring means;
h. either wire or wirelessly analyzing said predetermined parameters; and,
i. based on said predetermined parameters treating said patient.

It is another object of the present invention to provide the method as defined above, wherein said step (d) of analyzing provide diagnosis of said patient.

It is another object of the present invention to provide the method as defined above, additionally comprising steps of:
i. relaying said data to either to a remote or local, computerized or human expert;
j. receiving direction from said expert system;
k. alerting patient and their proximity of the decision to administer treatment;
l. prompting the patient and their proximity to raise objection to remote treatment;
m. activating said remote dispenser of medical treatment;
n. monitoring the effect of said remote treatment;
o. alerting first aid staff of the gravity of patient's situation;
p. dispatching a first aid staff to the patient's location.

It is another object of the present invention to provide the method as defined above, additionally comprising step of either wire or wirelessly transmitting at least one selected from a group consisting of (i) said analysis of said predetermined parameters; (ii) said predetermined parameters, or any combination thereof to an expert system adapted to perform an independence analysis of said predetermined parameters. It is another object of the present invention to provide the method as defined above, additionally comprising step of allowing said remote treatment administration by said treatment administration means by mean of said expert system.

It is another object of the present invention to provide the method as defined above, additionally comprising step of diagnosing said patient based upon said parameters by either one of said expert system or said computerized software program.

It is another object of the present invention to provide the method as defined above, additionally comprising step of feedbackly changing said treatment according to predetermined medical needs.

It is another object of the present invention to provide the method as defined above, additionally comprising step of providing said device with a feedback mechanism; said feedback mechanism comprising:
d. sensing means; adapted to sense predetermined parameters selected from a group consisting of blood pressure, heart rate, heart pulses, cardiac standstill, Ventricular tachycardia or V-tach or VT, Atrial fibrillation (AF or A-fib) or any combination thereof;
e. processing means, adopted to score said predetermined parameters according to a predetermined scale of treatment success; and,
f. regulating means, adapted to allow said treatment if said score is higher than a predetermined value and to stop said treatment if said score is lower than a predetermined value.

It is another object of the present invention to provide the method as defined above, additionally comprising steps of
d. sensing predetermined parameters selected from a group consisting of blood pressure, heart rate, heart pulses, cardiac standstill, Ventricular tachycardia or V-tach or VT, Atrial fibrillation (AF or A-fib) or any combination thereof;
e. scoring said predetermined parameters according to a predetermined scale of treatment success; and,
f. allowing said treatment if said score is higher than a predetermined value or stopping said treatment if said score is lower than a predetermined value

It is another object of the present invention to provide the method as defined above, additionally comprising step of implanting said device under the patient's skin.

It is another object of the present invention to provide the method as defined above, additionally comprising step of constructing said device in accordance with nanotechnology and containing the same within a capsule and ingested by the patient.

It is another object of the present invention to provide the method as defined above, additionally comprising step of constructing said device in accordance with nanotechnology and injecting the same into the patient's bloodstream.

It is another object of the present invention to provide the method as defined above, additionally comprising step of selecting said monitoring means from at least one electrode, at least one electro chemical probe, a conventional electro chemical blood sugar monitor or any combination thereof.

It is another object of the present invention to provide the method as defined above, additionally comprising step of either communicating said parameters via landline based, radio frequency, via satellite communication, via web server or any combination thereof.

It is another object of the present invention to provide the method as defined above, additionally comprising step of selecting said portable treatment administration means from defibrillator.

It is another object of the present invention to provide the method as defined above, additionally comprising step of transmitting a warning prior to remote activation of said defibrillator.

It is another object of the present invention to provide the method as defined above, additionally wherein said warning signal is audile, visual or any combination thereof.

It is another object of the present invention to provide the method as defined above, additionally comprising step of selecting said portable treatment administration means from intravenous drug dispenser.

It is another object of the present invention to provide the method as defined above, additionally comprising step ascertaining the consciousness of the patient.

It is another object of the present invention to provide the method as defined above, additionally comprising step of providing said computerized software program with an artificial intelligence based expert system.

It is another object of the present invention to provide the method as defined above, additionally comprising step of providing said computerized software program said integrated within a mobile phone.

It is still an object of the present invention to provide the method as defined above, additionally comprising step of providing said mobile phone incorporated a memory that records a history of monitored data.

It is lastly an object of the present invention to provide the method as defined above, additionally comprising step of providing said device with GPS device.

55. A device useful for monitoring of patient condition and remote treatment administration, comprising:
a. at least one portable monitoring means adapted to (i) acquire predetermined parameters from a patient for analysis; and. (ii) store said data in communicable database;
b. at least one portable treatment administration means for remote administration of medical treatment;
c. at least one computerized software program either wire or wirelessly connected with said mobile apparatus, adapted to (i) analyze said predetermined parameters acquired by said monitoring means; and, (ii) allow said remote treatment administration by said treatment administration means.

56. The device according to claim 55, wherein said computerized software program either wire or wirelessly transmit at least one selected from a group consisting of (i) said analysis of said predetermined parameters; (ii) said predetermined parameters, or any combination thereof to an expert system adapted to perform an independence analysis of said predetermined parameters; wherein said expert system further adapted to allow said remote treatment administration by said treatment administration means.

57. The device according to claim 55, wherein either one of said expert system or said computerized software program provides diagnosis of said patient based upon said parameters.

58. The device according to claim 55, additionally comprising at least one portable two way data communications apparatus; wherein said at least one remote interface enabling the remote control of said mobile computerized system, incorporating at least one two way communications means.

59. The device according to claim 55, additionally comprising a feedback mechanism, adapted to change said treatment according to predetermined medical needs; said feedback mechanism comprising:
a. sensing means; adapted to sense predetermined parameters selected from a group consisting of blood pressure, heart rate, heart pulses, cardiac standstill, Ventricular tachycardia or V-tach or VT, Atrial fibrillation (AF or A-fib) or any combination thereof;
b. processing means, adopted to score said predetermined parameters according to a predetermined scale of treatment success; and,
c. regulating means, adapted to allow said treatment if said score is higher than a predetermined value and to stop said treatment if said score is lower than a predetermined value.

60. The device of claim 55, wherein at least one of the following is being held true (a) said device is wearable; (b) said device is attachable and detachable from the patient; (c) said device is implanted under the patient's skin; (d) said device is constructed in accordance with nanotechnology and is contained within a capsule and ingested by the patient; (e) device is constructed in accordance with nanotechnology and is injected into the patient's bloodstream; and any combination thereof.

61. The device of claim 55, wherein the monitoring means comprises at least one selected from a group consisting of (a) at least one electrode; (b) at least one electro chemical probe; (c) a conventional electro chemical blood sugar monitor; and any combination thereof.

62. The device of claim 55, wherein the two way communication is at least one selected from a group consisting of (a) landline based communication; (b) radio frequency based communication; (c) satellite communication; (d) web server based communication; (e) incorporating a two way voice communication capability; (f) providing access to a remote artificial intelligence based expert system; any combination thereof.

63. The device of claim 55, wherein said apparatus for administration of medical treatment is a defibrillator.

64. The device of claim 63, wherein a warning is sounded prior to remote activation of said defibrillator.

65. The device of claim 64, wherein said warning is either audile or visual.

66. The device of claim 55, wherein at least one of the following is being held true (a) said portable treatment administration means comprises an intravenous drug dispenser; (b) said portable monitoring means is capable of ascertaining the consciousness of the patient; any combination thereof.

67. The device of claim 55, wherein said computerized software program includes an artificial intelligence based expert system.

68. The device of claim 55, wherein said computerized software program in integrated within a mobile phone; wherein said mobile phone incorporated a memory that records a history of monitored data.

69. The device of claim 55, additionally comprising GPS device.

70. A method of distance monitoring patients and provisioning medical treatment, said method comprising:
a. obtaining a mobile monitoring and medical treatment administration device, comprising
i. at least one portable monitoring means adapted to (i) acquire predetermined parameters from a patient for analysis; and. (ii) store said data in communicable database;
ii. at least one portable treatment administration means for remote administration of medical treatment; and,
iii. at least one computerized software program either wire or wirelessly connected with said mobile apparatus, adapted to (i) analyze said predetermined parameters acquired by said monitoring means; and, (ii) allow said remote treatment administration by said treatment administration means;
b. interconnecting said portable monitoring means and said portable treatment administration means to said patient;
c. monitoring said patient's condition by means of said portable monitoring means;
d. either wire or wirelessly analyzing said predetermined parameters; thereby diagnosing said patient; and,
e. based on said predetermined parameters treating said patient.

71. The method of claim 70, additionally comprising steps of:
a. relaying said data to either to a remote or local, computerized or human expert;
b. receiving direction from said expert system;
c. alerting patient and their proximity of the decision to administer treatment;
d. prompting the patient and their proximity to raise objection to remote treatment;
e. activating said remote dispenser of medical treatment;
f. monitoring the effect of said remote treatment;
g. alerting first aid staff of the gravity of patient's situation;
h. dispatching a first aid staff to the patient's location.

72. The method according to claim 71, additionally comprising step of either wire or wirelessly transmitting at least one selected from a group consisting of (i) said analysis of said predetermined parameters; (ii) said predetermined parameters, or any combination thereof to an expert system adapted to perform an independence analysis of said predetermined parameters.

73. The method according to claim 71, additionally comprising at least one step selected from a group consisting of (a) diagnosing said patient based upon said parameters by either one of said expert system or said computerized software program; (b) feedbackly changing said treatment according to predetermined medical needs; (c) allowing said remote treatment administration by said treatment administration means by mean of said expert system; (d) implanting said device under the patient's skin; (e) constructing said device in accordance with nanotechnology and containing the same within a capsule and ingested by the patient; (f) constructing said device in accordance with nanotechnology and injecting the same into the patient's bloodstream; (g) selecting said monitoring means from at least one electrode, at least one electro chemical probe, a conventional electro chemical blood sugar monitor or any combination thereof; (h) either communicating said parameters via landline based, radio frequency, via satellite communication, via web server or any combination thereof; and any combination thereof.

74. The method according to claim 71, additionally comprising step of providing said device with a feedback mechanism; said feedback mechanism comprising:
a. sensing means; adapted to sense predetermined parameters selected from a group consisting of blood pressure, heart rate, heart pulses, cardiac standstill, Ventricular tachycardia or V-tach or VT, Atrial fibrillation (AF or A-fib) or any combination thereof;
b. processing means, adopted to score said predetermined parameters according to a predetermined scale of treatment success; and,
c. regulating means, adapted to allow said treatment if said score is higher than a predetermined value and to stop said treatment if said score is lower than a predetermined value.

75. The method according to claim 71, additionally comprising steps of:
a. sensing predetermined parameters selected from a group consisting of blood pressure, heart rate, heart pulses, cardiac standstill, Ventricular tachycardia or V-tach or VT, Atrial fibrillation (AF or A-fib) or any combination thereof;
b. scoring said predetermined parameters according to a predetermined scale of treatment success; and,
c. allowing said treatment if said score is higher than a predetermined value or stopping said treatment if said score is lower than a predetermined value.

76. The method according to claim 71, additionally comprising at least one step selected from a group consisting of (a) selecting said portable treatment administration means from defibrillator and transmitting a warning prior to remote activation of said defibrillator; wherein said warning signal is audile, visual or any combination thereof; (b) selecting said portable treatment administration means from intravenous drug dispenser; (c) ascertaining the consciousness of the patient; (d) providing said computerized software program with an artificial intelligence based expert system; (e) providing said computerized software program said integrated within a mobile phone; (f) providing said mobile phone incorporated a memory that records a history of monitored data; (g) providing said device with GPS device; and any combination thereof.
